(19) United States
(12) Patent Application Publication
(10) Pub. No.: US 2012/0295112 A1
(43) Pub. Date: Nov. 22, 2012

(54) SILICON CARBIDE POWDER AND METHOD FOR PRODUCING SILICON CARBIDE POWDER

(75) Inventors: Makoto Sasaki, Itami-shi (JP); Hiroki Inoue, Itami-shi (JP)

(73) Assignee: SUMITOMO ELECTRIC INDUSTRIES, LTD., Osaka-shi (JP)

(21) Appl. No.: 13/465,296

(22) Filed: May 7, 2012

Related U.S. Application Data
(60) Provisional application No. 61/487,529, filed on May 18, 2011.

(30) Foreign Application Priority Data
May 18, 2011 (JP) 2011-110959

(51) Int. Cl. C01B 31/36; B32B 5/16

(52) U.S. Cl. 428/402; 423/345

(57) ABSTRACT

There are provided a silicon carbide powder for silicon carbide crystal growth and a method for producing the silicon carbide powder. The silicon carbide powder is formed by heating a mixture of a silicon small piece and a carbon powder and thereafter pulverizing the mixture, and is substantially composed of silicon carbide.

### BACKGROUND OF THE INVENTION

1. Field of the Invention

The present invention relates to a silicon carbide powder and a method for producing the silicon carbide powder.

2. Description of the Background Art

In recent years, silicon carbide (SiC) single-crystals have been used as semiconductor substrates for use in manufacturing semiconductor devices. SiC has a band gap larger than that of silicon (Si), which has been used more commonly. Hence, a semiconductor device employing SiC advantageously has a large breakdown voltage, low on-resistance, and properties less likely to decrease in a high temperature environment. For this reason, the semiconductor device employing SiC has been drawing attention.

For example, Patent Literature 1 (Japanese Patent Laying-Open No. 2005-314217) discloses a method for producing a source material for growth of SiC single-crystal. Here, Patent Literature 1 discloses a method for preparing a source material for growth of a SiC single-crystal by providing high temperature heat treatment to at least a carbon (C) source material at a temperature of not less than 1400° C. and not more than 2600° C. under inert gas atmosphere with a pressure of 1.3 Pa or smaller so as to achieve a boron concentration of 1 ppm or smaller, and then mixing it with a silicon source material having a boron concentration smaller than that of the carbon source material (for example, see claim 1 of Patent Literature 1).

### SUMMARY OF THE INVENTION

However, in the method described in Patent Literature 1, for the reduction of boron concentration, it is necessary to perform the step of previously providing the high temperature heat treatment to the carbon source material at a temperature of not less than 1400° C. and not more than 2600° C. under the inert gas atmosphere with a pressure of 1.3 Pa or smaller. Also in the method described in Patent Literature 1, it is necessary to prepare the silicon source material having a boron concentration lower than the carbon source material's boron concentration reduced by providing the pretreatment as described above.

As a result of analyzing the source material prepared by means of the method described in Patent Literature 1 in accordance with an X-ray diffraction method with different X-ray penetration depths, it was found that SiC was only formed in a surface portion of the source material and C existed as a simple substance within the source material.

When growing a SiC single-crystal using such a source material having SiC formed only in its surface, a large amount of the source material needs to be introduced into a crucible to obtain a predetermined amount of SiC single-crystal due to the small filling ratio thereof.

In view of the above-described circumstances, the present invention has its object to provide a silicon carbide powder that can be more readily produced and that contains high-purity silicon carbide, as well as a method for producing such a silicon carbide powder.

The present invention provides a silicon carbide powder for silicon carbide crystal growth, wherein the silicon carbide powder is formed by heating a mixture of a silicon small piece and a carbon powder and thereafter pulverizing the mixture and is substantially composed of silicon carbide.

Here, carbon preferably exists as a simple substance in the silicon carbide powder of the present invention at a content of 50 mass % or smaller.

Further, carbon preferably exists as a simple substance in the silicon carbide powder of the present invention at a content of 10 mass % or smaller.

Further, the silicon carbide powder of the present invention preferably contains boron at a content of 0.5 ppm or smaller and contains aluminum at a content of 1 ppm or smaller.

Further, the silicon carbide powder of the present invention preferably has an average grain diameter of not less than 10 μm and not more than 2 mm.

The present invention provides a method for producing a silicon carbide powder for silicon carbide crystal growth, including the steps of: preparing a mixture by mixing a silicon small piece and a carbon powder; preparing a silicon carbide powder precursor by heating the mixture to not less than 2000° C. and not more than 2500° C.; and preparing the silicon carbide powder by pulverizing the silicon carbide powder precursor.

Here, in the method for producing the silicon carbide powder in the present invention, the carbon powder preferably has an average grain diameter of not less than 10 μm and not more than 200 μm.

According to the present invention, there can be provided a silicon carbide powder that can be more readily produced and that contains high-purity silicon carbide, as well as a method for producing such a silicon carbide powder.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross sectional view illustrating a part of a production process in one exemplary method for producing a silicon carbide powder for silicon carbide crystal growth in the present invention.

FIG. 2 is a schematic plan view of one exemplary silicon small piece used in the present invention.

FIG. 3 is a schematic plan view of one exemplary silicon carbide powder precursor prepared in the step of preparing a silicon carbide powder precursor in the present invention.

FIG. 4 shows a profile showing temperature of a graphite crucible and pressure of an electric furnace relative to elapsed time in example 1.

### DESCRIPTION OF THE PREFERRED EMBODIMENTS

The following describes an exemplary method for producing silicon carbide powder for silicon carbide crystal growth in the present invention. It should be noted that other step(s) may be included to come before or after each of steps described below.

<Step of Preparing Mixture>

Performed first is a step of preparing a mixture 3 by mixing silicon small pieces 1 and carbon powders 2 as shown in a schematic cross sectional view of FIG. 1. The step of preparing mixture 3 can be performed by, for example, introducing silicon small pieces 1 and carbon powders 2 into a graphite crucible 4 and mixing them in graphite crucible 4 to prepare mixture 3. Alternatively, mixture 3 may be prepared by mixing silicon small pieces 1 and carbon powders 2 before introducing them into graphite crucible 4.

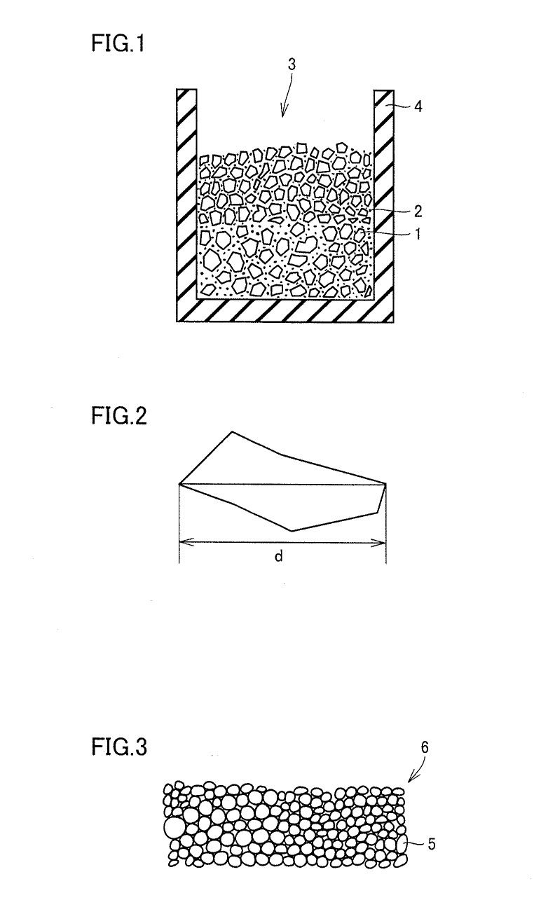

Here, as each of silicon small pieces 1, for example, it is preferable to use a silicon small piece 1 having a diameter d, which is shown in a schematic plan view of FIG. 2, of not less than 0.1 mm and not more than 5 cm. It is more preferable to use a silicon small piece 1 having a diameter d of not less than 1 mm and not more than 1 cm. In this case, high-purity silicon carbide powders formed of silicon carbide up to its inside are likely to be obtained. It should be noted that the term “diameter” herein is intended to mean the length of the longest one of line segments connecting two points in the surface thereof.

As each of carbon powders 2, it is preferable to use a carbon powder having an average grain diameter (average value of respective diameters of carbon powders 2) of not less than 10 μm and not more than 200 μm. In this case, high-purity silicon carbide powders formed of silicon carbide up to its inside are likely to be obtained.

<Step of Preparing Silicon Carbide Powder Precursor>

Performed next is the step of preparing a silicon carbide powder precursor by heating mixture 3 prepared as described above, to not less than 2000° C. and not more than 2500° C. The step of preparing the silicon carbide powder precursor can be performed by heating mixture 3, which includes silicon small pieces 1 and carbon powders 2 and contained in graphite crucible 4 as described above, to a temperature of not less than 2000° C. and not more than 2500° C. under an inert gas atmosphere with a pressure of not less than 1 kPa and not more than 1.02×10⁵ Pa, in particular, not less than 10 kPa and not more than 70 kPa, for example. Accordingly, in graphite crucible 4, silicon of silicon small pieces 1 and carbon of carbon powders 2 react with each other to form silicon carbide, which is a compound of silicon and carbon. In this way, the silicon carbide powder precursor is prepared.

Here, if the heating temperature is smaller than 2000° C., the reaction of silicon and carbon does not proceed to reach the inside thereof because the heating temperature is too low. This results in failure of preparing a high-purity silicon carbide powder precursor formed of silicon carbide up to its inside. In contrast, if the heating temperature exceeds 2500° C., the reaction of silicon and carbon proceeds too much to desorb silicon from silicon carbide formed by the reaction of silicon and carbon because the heating temperature is too high. This results in failure of preparing a high-purity silicon carbide powder precursor formed of silicon carbide up to its inside.

In the description above, as the inert gas, there can be used a gas including at least one selected from a group consisting of argon, helium, and nitrogen, for example.

Further, mixture 3 of silicon small pieces 1 and carbon powders 2 is preferably heated for not less than 1 hour and not more than 100 hours. In this case, the reaction of silicon and carbon can be likely to be sufficiently done, thereby preparing an excellent silicon carbide powder precursor.

Further, it is preferable to perform the step of decreasing the pressure of the atmosphere after the above-described heating. In this case, silicon carbide is likely to be formed up to the inside of each of below-described silicon carbide crystal grains constituting the silicon carbide powder precursor.

Here, in the case where the pressure of the atmosphere is decreased to a pressure of 10 kPa or smaller in the step of decreasing the pressure of the atmosphere, it preferably takes 10 hours or shorter to decrease the pressure, more preferably takes 5 hours or shorter, and further preferably takes 1 hour or shorter. When the pressure is decreased for 10 hours or shorter, more preferably 5 hours or shorter, in particular, 1 hour or shorter, the desorption of silicon from the silicon carbide formed by the reaction of silicon and carbon can be suitably suppressed, whereby an excellent silicon carbide powder precursor can be likely to be prepared.

Further, after decreasing the pressure of the atmosphere to a pressure of 10 kPa or smaller as described above, the pressure of the atmosphere may be increased to a pressure of 50 kPa or greater by supplying an inert gas thereto and then the silicon carbide powder precursor may be cooled to a room temperature (25° C.). Alternatively, with the pressure being maintained at 10 kPa or smaller, the silicon carbide powder precursor may be cooled to the room temperature (25° C.).

FIG. 3 shows a schematic plan view of one example of the silicon carbide powder precursor prepared by the step of preparing the silicon carbide powder precursor. Here, silicon carbide powder precursor 6 is an aggregate of the plurality of silicon carbide crystal grains 5, and is constituted of silicon carbide crystal grains 5 connected to one another.

<Step of Preparing Silicon Carbide Powder>

Performed next is the step of preparing silicon carbide powders by pulverizing silicon carbide powder precursor 6 prepared as described above. The step of preparing the silicon carbide powders can be performed by pulverizing silicon carbide powder precursor 6, which is the aggregate of the plurality of silicon carbide crystal grains 5 shown in FIG. 3, using a single-crystal or polycrystal silicon carbide ingot or a tool coated with silicon carbide of single-crystal or polycrystal, for example.

If silicon carbide powder precursor 6 is pulverized using an object other than the silicon carbide single-crystal or polycrystal, it is preferable to clean the silicon carbide powders using an acid including at least one selected from a group consisting of hydrochloric acid, aqua regia, and hydrofluoric acid, for example. For example, if silicon carbide powder precursor 6 is pulverized using an object made of steel, metal impurities such as iron, nickel, and cobalt are likely to be mixed in or adhered to the silicon carbide powders thus obtained by the pulverization. In order to remove such metal impurities, it is preferable to clean them using the above-described acid.

<Silicon Carbide Powder>

Not only the surface but also the inside of each of the silicon carbide powders prepared as described above are highly likely to be formed of silicon carbide. Hence, the silicon carbide powder is substantially composed of silicon carbide. It should be noted that the expression “substantially composed of silicon carbide” is intended to mean that 99 mass % or greater of the silicon carbide powder is formed of silicon carbide.

For example, in the source material prepared by the conventional method described in Patent Literature 1, the content of impurity formed of carbon existing as a simple substance in the surface portion is small, but the content of carbon existing as a simple substance in the surface portion and the inside thereof is greater than 50 mass %. In Patent Literature 1, only the surface of the source material was analyzed using the X-ray diffraction method, and the inside thereof was not analyzed using the X-ray diffraction method with increased X-ray penetration depths. Hence, in Patent Literature 1 of the conventional art, it has not been noticed that carbon existed as a simple substance because the reaction of silicon and carbon had not proceeded to the inside of the source material prepared by the conventional method described in Patent Literature 1.

In contrast, the reaction proceeds to form silicon carbide inside the silicon carbide powder of the present invention, as compared with the source material prepared by the conventional method described in Patent Literature 1. Accordingly, the content of carbon existing as a simple substance in the silicon carbide powder can be 50 mass % or smaller of the silicon carbide powder, preferably, 10 mass % or smaller. Thus, the silicon carbide powder in the present invention can be a silicon carbide powder containing high-purity silicon carbide.

Because the silicon carbide powder of the present invention is formed of the high-purity silicon carbide as described above, the content of boron can be 0.5 ppm or smaller and the content of aluminum can be 1 ppm or smaller in the silicon carbide powder. Specifically, the content of boron in the silicon carbide powder of the present invention is 0.00005 mass % or smaller of the entire silicon carbide powder, and the content of aluminum therein is 0.0001 mass % or smaller of the entire silicon carbide powder.

Further, the average grain diameter of the silicon carbide powders in the present invention is preferably not less than 10 μm and not more than 2 mm. When the average grain diameter of silicon carbide powder is not less than 10 μm and not more than 2 mm, graphite crucible 4 can be filled with the silicon carbide powders at a high filling ratio for crystal growth of silicon carbide crystal and the rate of silicon carbide crystal growth is likely to be large. It should be noted that the term “average grain diameter of the silicon carbide powders” is intended to mean an average value of respective diameters of the individual silicon carbide powders.

As described above, in the present invention, unlike in the conventional method described in Patent Literature 1, it is not necessary to perform the pretreatment onto the carbon source material and prepare the silicon source material having a boron concentration lower than that of the carbon source material having been through the pretreatment. Thus, in the present invention, the silicon carbide powders for silicon carbide crystal growth can be more readily produced.

Further, carbon is highly likely to remain as a simple substance inside the source material prepared by the conventional method described in Patent Literature 1. In contrast to the source material prepared by the conventional method described in Patent Literature 1, in the present invention, the reaction of silicon and carbon proceeds to reach the inside of each of the silicon carbide powders to form silicon carbide in the inside thereof, thereby obtaining powders formed of high-purity silicon carbide. Accordingly, in the present invention, an amount of silicon carbide powders to fill the crucible for growth of silicon carbide crystal can be reduced as compared with the case of using the source material described in Patent Literature 1 of the conventional art. Hence, a ratio of the source material to be introduced into the crucible can be low. Hence, in the present invention, the crucible used for the production of the silicon carbide crystal can be reduced in size, which leads to device size reduction. In the case of using a crucible as large as the crucible described in Patent Literature 1 of the conventional art, a larger silicon carbide crystal can be grown.

Further, the silicon carbide powder of the present invention is formed of high-purity and high-density silicon carbide. Hence, when growing a silicon carbide crystal using the silicon carbide powder of the present invention, an average crystal growth rate of the silicon carbide crystal can be larger than that in the case of using the source material described in Patent Literature 1 of the conventional art. Hence, when preparing a silicon carbide crystal using the silicon carbide powders of the present invention, the silicon carbide crystal can be produced more efficiently.

As described above, according to the present invention, silicon carbide powders containing high-purity silicon carbide can be readily produced.

### EXAMPLES

### Example 1

First, as the silicon small pieces, a plurality of silicon small pieces were prepared each of which had a diameter of not less than 1 mm and not more than 1 cm. As the carbon powders, carbon powders were prepared which had an average grain diameter of 200 μm. Here, each of the silicon small pieces was a silicon chip having a purity of 99.999999999% for silicon single-crystal pulling.

Next, 154.1 g of the silicon small pieces and 65.9 g of the carbon powders were lightly mixed to obtain a mixture, which was then introduced into a graphite crucible. The graphite crucible used here had been heated in advance to 2300° C. in a high-frequency heating furnace under argon gas with a reduced pressure of 0.013 Pa, and had been held for 14 hours.

Next, the graphite crucible having the mixture of the silicon small pieces and the carbon powders therein as described above was put in an electric heating furnace, and was vacuumed to 0.01 Pa. The atmosphere was then substituted with argon gas having a purity of 99.9999% or greater to achieve a pressure of 70 kPa in the electric furnace.

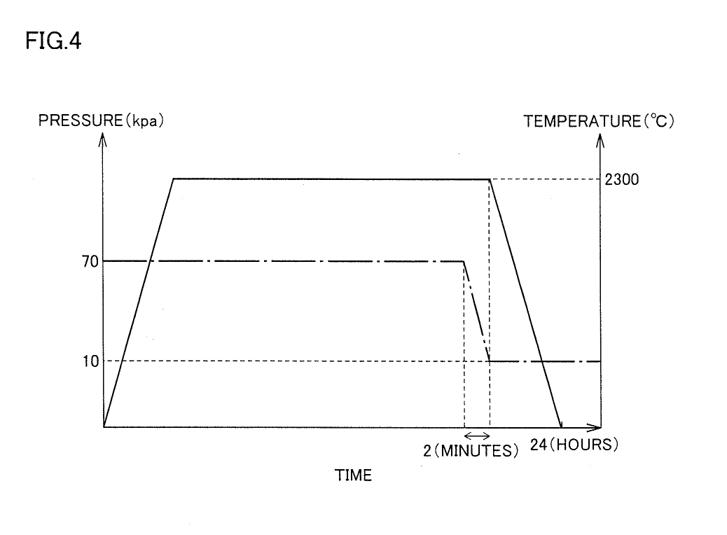

Next, as shown in FIG. 4, with the pressure being maintained at 70 kPa in the electric furnace, the graphite crucible containing the mixture of the silicon small pieces and the carbon powders were heated to 2300° C. and held at this temperature for 20 hours. Thereafter, the pressure in the electric furnace was reduced to 10 kPa within 2 minutes. Thereafter, the temperature of the graphite crucible was decreased to a room temperature (25° C.). FIG. 4 shows a profile of the temperature of the graphite crucible and the pressure in the electric furnace relative to elapsed time. It should be noted that in FIG. 4, a solid line represents a change of the temperature of the graphite crucible, and a dashed line represents a change of the pressure in the electric furnace.

Next, a silicon carbide powder precursor prepared by the above-described heat treatment was taken out from the graphite crucible. Here, as a result of observing the silicon carbide powder precursor, the silicon carbide powder precursor was found to be constituted of an aggregate of a plurality of individual silicon carbide crystal grains connected to one another.

Next, the silicon carbide powder precursor obtained as described above was pulverized using a tool coated with a silicon carbide polycrystal, thereby preparing silicon carbide powders of example 1. Here, the silicon carbide powders of example 1 had an average grain diameter of 20 μm.

The silicon carbide powders of example 1 obtained as described above were subjected to qualitative analysis by means of a powder X-ray diffraction method. With Cu being set as a target for the X ray, the penetration depth of the X ray can be 10 μm or greater. Accordingly, components constituting the inside of each silicon carbide powder of example 1 can be specified.

As a result of performing qualitative analysis and quantitative analysis (simple quantitative measurement) on the components of the silicon carbide powder of example 1 using the above-described powder X-ray diffraction method (θ-20 scan), it was confirmed that a ratio of an integrated value of an X-ray diffraction peak indicating existence of C relative to a total of integrated values of X-ray diffraction peaks respectively corresponding to all the components constituting the silicon carbide powder (100×(the integrated value of the X-ray diffraction peak indicating existence of C)/(the total of the integrated values of the X-ray diffraction peaks respectively corresponding to all the components constituting the silicon carbide powder)) was smaller than 1%. It was also confirmed that a ratio of an integrated value of an X-ray diffraction peak indicating existence of SiC relative to the total of integrated values of the X-ray diffraction peaks respectively corresponding to all the components constituting the silicon carbide powder (100×(the integrated value of the X-ray diffraction peak indicating existence of SiC)/(the total of the integrated values of the X-ray diffraction peaks respectively corresponding to all the components constituting the silicon carbide powder)) was 99% or greater. Thus, it is considered that the silicon carbide powder of example 1 was a high-purity silicon carbide powder substantially completely formed of silicon carbide up to its inside (silicon carbide at a content of 99 mass % or greater) and containing carbon existing as a simple substance at a content of less than 1 mass %.

In addition, the integrated values of the X-ray diffraction peaks of the silicon carbide powder of example 1 with the powder X-ray diffraction method were compared. As a result, it was confirmed that the content of boron was 0.5 ppm or smaller and the content of aluminum was 1 ppm or smaller in the silicon carbide powder.

### Example 2

Silicon carbide powders of example 2 were prepared in the same way as that of example 1 except that the pressure in the electric furnace was not reduced, and then was subjected to qualitative analysis and quantitative analysis using the powder X-ray diffraction method under the same conditions as those in example 1.

As a result, it was confirmed that a ratio of an integrated value of an X-ray diffraction peak indicating existence of C relative to a total of integrated values of X-ray diffraction peaks respectively corresponding to all the components constituting the silicon carbide powder was smaller than 1%. It was also confirmed that a ratio of an integrated value of an X-ray diffraction peak indicating existence of SiC relative to the total of integrated values of the X-ray diffraction peaks respectively corresponding to all the components constituting the silicon carbide powder was 99% or greater. Thus, it is considered that the silicon carbide powder of example 2 was also a high-purity silicon carbide powder substantially completely formed of silicon carbide up to its inside (silicon carbide at a content of 99 mass % or greater) and containing carbon existing as a simple substance at a content of less than 1 mass %.

In addition, the integrated values of the X-ray diffraction peaks of the silicon carbide powder of example 2 with the powder X-ray diffraction method were compared. As a result, it was confirmed that the content of boron was 0.5 ppm or smaller and the content of aluminum was 1 ppm or smaller in the silicon carbide powder.

### Example 3

Silicon carbide powders of example 3 were prepared in the same way as that of example 1 except that the heating temperature of the graphite crucible was set at 2000° C., and then was subjected to qualitative analysis and quantitative analysis using the powder X-ray diffraction method under the same conditions as those in example 1.

As a result, it was confirmed that a ratio of an integrated value of an X-ray diffraction peak indicating existence of C relative to a total of integrated values of X-ray diffraction peaks respectively corresponding to all the components constituting the silicon carbide powder was smaller than 1%. It was also confirmed that a ratio of an integrated value of an X-ray diffraction peak indicating existence of SiC relative to the total of integrated values of the X-ray diffraction peaks respectively corresponding to all the components constituting the silicon carbide powder was 99% or greater. Thus, it is considered that the silicon carbide powder of example 3 was also a high-purity silicon carbide powder substantially completely formed of silicon carbide up to its inside (silicon carbide at a content of 99 mass % or greater) and containing carbon existing as a simple substance at a content of less than 1 mass %.

In addition, the integrated values of the X-ray diffraction peaks of the silicon carbide powder of example 3 with the powder X-ray diffraction method were compared. As a result, it was confirmed that the content of boron was 0.5 ppm or smaller and the content of aluminum was 1 ppm or smaller in the silicon carbide powder.

### Example 4

Silicon carbide powders of example 4 were prepared in the same way as that of example 1 except that the heating temperature of the graphite crucible was set at 2500° C., and then was subjected to qualitative analysis and quantitative analysis using the powder X-ray diffraction method under the same conditions as those in example 1.

As a result, it was confirmed that a ratio of an integrated value of an X-ray diffraction peak indicating existence of C relative to a total of integrated values of X-ray diffraction peaks respectively corresponding to all the components constituting the silicon carbide powder was smaller than 1%. It was also confirmed that a ratio of an integrated value of an X-ray diffraction peak indicating existence of SiC relative to the total of integrated values of the X-ray diffraction peaks respectively corresponding to all the components constituting the silicon carbide powder was 99% or greater. Thus, it is considered that the silicon carbide powder of example 4 was also a high-purity silicon carbide powder substantially completely formed of silicon carbide up to its inside (silicon carbide at a content of 99 mass % or greater) and containing carbon existing as a simple substance at a content of less than 1 mass %.

In addition, the integrated values of the X-ray diffraction peaks of the silicon carbide powder of example 4 with the powder X-ray diffraction method were compared. As a result, it was confirmed that the content of boron was 0.5 ppm or smaller and the content of aluminum was 1 ppm or smaller in the silicon carbide powder.

### Comparative Example 1

First, as a carbon source material, high-purity carbon powders having been through heat treatment at 2000° C. or greater in halogen gas were prepared. As a silicon source material, silicon chips each having a purity of 99.999999999% for silicon single crystal pulling were prepared.

Here, the carbon source material was subjected to pretreatment as follows: the carbon source material was introduced into a graphite crucible, was heated together with the graphite crucible to about 2200° C. in a high-frequency heating furnace under argon gas with a reduced pressure to 0.013 Pa in advance, and was held for 15 hours.

It should be noted that boron concentrations of the carbon source material and the silicon source material both having been through the above-described pretreatment were measured by means of GDMS (glow discharge mass spectrometry) measurement and were found to be 0.11 ppm and 0.001 ppm or smaller respectively.

Meanwhile, the silicon chips, which were the silicon source material, mainly were several mm to ten several mm in size. The carbon source material having been through the pretreatment had an average grain diameter of 92 μm.

Next, 65.9 g of the carbon source material and 154.1 g of the silicon source material were lightly mixed, and mixed powders of the carbon source material and the silicon source material were introduced into the above-described graphite crucible.

Next, the graphite crucible thus containing the carbon source material and the silicon source material was put in an electric heating furnace. Then, pressure in the electric furnace was vacuumed to 0.01 Pa. Thereafter, the atmosphere was substituted with argon gas having a purity of 99.9999% or greater to achieve a pressure of 80 kPa in the electric furnace. While adjusting the pressure in this electric furnace, heating was performed to 1420° C., which was then held for 2 hours. Thereafter, further heating was performed to 1900° C., which was then held for 3 hours. Thereafter, the temperature was decreased.

Comparative example 1 obtained as described above was subjected to qualitative analysis and quantitative analysis using the powder X-ray diffraction method under the same conditions as those in example 1.

As a result, it was confirmed that a ratio of an integrated value of an X-ray diffraction peak indicating existence of C relative to a total of integrated values of X-ray diffraction peaks respectively corresponding to all the components constituting the silicon carbide powder was greater than 50%. Hence, it is considered that the inside of the silicon carbide powder of comparative example 1 was almost formed of carbon and the content of carbon existing as a simple substance was greater than 50 mass %.

### Comparative Example 2

Silicon carbide powders of comparative example 2 were prepared in the same way as that of example 1 except that the heating temperature of the graphite crucible was set at 1950° C., and then was subjected to qualitative analysis and quantitative analysis using the powder X-ray diffraction method under the same conditions as those in example 1.

As a result, it was confirmed that a ratio of an integrated value of an X-ray diffraction peak indicating existence of C relative to a total of integrated values of X-ray diffraction peaks respectively corresponding to all the components constituting the silicon carbide powder was greater than 50%. Hence, it is considered that the inside of the silicon carbide powder of comparative example 3 was almost formed of carbon and the content of carbon existing as a simple substance was greater than 50 mass %. This is presumably because the heating temperature of the graphite crucible was too low, with the result that the reaction of silicon and carbon did not proceed to the inside thereof.

### Comparative Example 3

Silicon carbide powders of comparative example 3 were prepared in the same way as that of example 1 except that the heating temperature of the graphite crucible was set at 2550° C., and then were subjected to qualitative analysis and quantitative analysis using the powder X-ray diffraction method under the same conditions as those in example 1.

As a result, it was confirmed that a ratio of an integrated value of an X-ray diffraction peak indicating existence of C relative to a total of integrated values of X-ray diffraction peaks respectively corresponding to all the components constituting the silicon carbide powder was greater than 50%. Hence, it is considered that the inside of the silicon carbide powder of comparative example 4 was also almost formed of carbon and the content of carbon existing as a simple substance was greater than 50 mass %. This is presumably because the heating temperature of the graphite crucible is too high, with the result that silicon was desorbed from silicon carbide generated by the reaction of silicon and carbon.

The present invention can be used for a silicon carbide powder and a method for producing the silicon carbide powder.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A silicon carbide powder for silicon carbide crystal growth, wherein the silicon carbide powder is formed by heating a mixture of a silicon small piece and a carbon powder and thereafter pulverizing the mixture and is substantially composed of silicon carbide.

2. The silicon carbide powder according to claim 1, wherein carbon exists as a simple substance in said silicon carbide powder at a content of 50 mass % or smaller.

3. The silicon carbide powder according to claim 1, wherein carbon exists as a simple substance in said silicon carbide powder at a content of 10 mass % or smaller.

4. The silicon carbide powder according to claim 1, wherein said silicon carbide powder contains boron at a content of 0.5 ppm or smaller and contains aluminum at a content of 1 ppm or smaller.

5. The silicon carbide powder according to claim 1, wherein said silicon carbide powder has an average grain diameter of not less than 10 μm and not more than 2 mm.

6. A method for producing a silicon carbide powder for silicon carbide crystal growth, comprising the steps of:
preparing a mixture by mixing a silicon small piece and a carbon powder;
preparing a silicon carbide powder precursor by heating said mixture to not less than 2000° C. and not more than 2500° C.; and
preparing said silicon carbide powder by pulverizing said silicon carbide powder precursor.

7. The method for producing the silicon carbide powder according to claim 6, wherein said carbon powder has an average grain diameter of not less than 10 μm and not more than 200 μm.
